(19) United States
(12) Patent Application Publication
(10) Pub. No.: US 2021/0084908 A1
(43) Pub. Date: Mar. 25, 2021

(54) BIO-STIMULANT FORMULATION

(71) Applicant: Charles Colin Bender, Montana Park (ZA)

(72) Inventor: Charles Colin Bender, Montana Park (ZA)

(21) Appl. No.: 16/971,946

(22) PCT Filed: Feb. 25, 2019
(86) PCT No.: PCT/IB2019/051493

§ 371 Date: Aug. 21, 2020

(30) Foreign Application Priority Data
Feb. 23, 2018 (ZA) 2018/01230

(51) Int. Cl. A01N 65/03; A01N 43/16; A01N 63/20; A01N 63/30; A01N 63/40; A01N 63/50; C05G 3/60

(52) U.S. Cl. CPC A01N 65/03; A01N 43/16; A01N 63/20; C05G 3/60; A01N 63/40; A01N 63/50; A01N 63/30

(57) ABSTRACT

The invention relates to a bio-stimulant comprising seaweed and an isoflavone and/or a plant elicitor. The seaweed and isoflavone and/or plant elicitor, such as harpin, may be combined with any one or more of a biological, nutrient, wax and pesticide. The formulation is suitable for soil and wet or dry seed applications. For dry seed applications, a fluency agent such as wax is added.

### FIELD OF THE INVENTION

This invention relates to a bio-stimulant formulation and method for preparing same. More particularly, but not exclusively, this invention relates to an agricultural bio-stimulant formulation and method for preparing the formulation for promoting healthy soil, the stimulation of a plant, soil or seed and its unique method of application.

### BACKGROUND TO THE INVENTION

The use of bio-stimulants in the agricultural industry is well known to, inter alia, improve plant metabolism for increased crop yields and quality by increasing nutrient assimilation; render plants more water efficient; to improve tolerance of and recovery from abiotic stresses and to enhance soil fertility. Bio-stimulants are different from traditional chemical treatments or nutritional supplements as it is biologically derived and may include micro-organisms and excludes the traditional chemical substances used in agriculture. It acts by stimulating natural processes within the plant or soil to increase vigour, rather than acting against pests or disease. The improved vigour of the plant or health of the soil enables the plant to efficiently combat attacks by pests or diseases, thereby decreasing the amount of pesticide use. It provides a highly effective and environmentally friendly alternative to the normal chemical treatments.

Bio-stimulants are normally provided in a powdered form, which is suspended or dissolved in water. The bio-stimulant enriched water is then sprayed over the seeds before planting, which needs to occur days before planting to allow the seeds to dry. The dried seeds are then planted using a standard planter. It is important to ensure that the seeds are completely dry, as wet seeds may cause blockages in the planter. Advances in the art provides that some bio-stimulants can be applied on demand as a dry powder, directly into the seed bin of the planter containing the seeds, and does not require a waiting period between application of the bio-stimulant at planting. Additionally, the farmer saves on labour, equipment and electricity costs by directly introducing the bio-stimulant powder to the seeds. These bio-stimulant powders may still cause blockages and additionally, the seeds are not evenly coated with the bio-stimulant powder. To solve this problem, farmers add a seed lubricator or fluency agent to the seed bin, together with the bio-stimulant powder and the seeds to be planted. Talc and graphite are frequently used as seed lubricators, but a major drawback of these compounds is that it causes a lot of dust and the planter and seed bin must be cleaned after planting. Newer, more advanced, wax based lubricators are available, which does not clog the planter and forms substantially less dust and furthermore does not require the planter and seed bin to be cleaned after planting. This wax-based lubricant additionally allows for the bio-stimulant powder to better adhere to the seeds as well as ensures an even coating covering the seeds, but these lubricants are fairly expensive.

At present, the farmer will select a bio-stimulant according to the characteristic of the plant or the soil which needs to be enhanced, whether it be increased yield, improved drought tolerance, increased soil fertility or tolerance to pests and diseases. The disadvantage associated with this practice is that the farmer cannot influence all the factors simultaneously by adding all different bio-stimulants to the seeds at once, because the seeds will not be evenly and equally coated by the different bio-stimulants. When applying some bio-stimulants, a larger amount than necessary to effect the desired improvement of the plant may be required, as some of the powder inevitably does not stick to the seed and goes to waste.

The application of bio-stimulants to the soil is used to stimulate new root development and to activate soil microorganisms and enrich soil health. Soil health is becoming a big concern for sustainable farming. Currently, many bio-stimulants are provided as separate components and hence requires the mixing, at the correct ratios, of the various bio-stimulants. A disadvantage of this is that users do not always know which bio-stimulants can be applied together that create synergistic effects by combining them correctly. Careful attention to storing and mixing of the separate bio-stimulants is therefore essential and subsequent incorrect application may lead to ineffective usage of bio-stimulants and may even cause more damage than good to the soil along with unnecessary wastage of bio-stimulants. Acquiring a number of different bio-stimulants furthermore places an undue burden in terms of storage, costs and safety requirements.

In addition, often, if not always, a separate food source must be applied to a biological product, in order to keep them alive long enough to ensure the benefits. This exacerbates some of the disadvantages mentioned above.

It is accordingly essential that the application of bio-stimulants to soil, plant or seed is carefully managed in terms of safety and efficacy aspects to ensure sustainable and effective agriculture.

### OBJECT OF THE INVENTION

It is accordingly an object of the present invention to provide a bio-stimulant formulation and method for preparing same that seeks to overcome or, at least partially, alleviate the abovementioned problems and/or to provide useful alternatives to known bio-stimulant formulations and their method of application.

### SUMMARY OF THE INVENTION

According to a first aspect of the invention, there is provided a bio-stimulant formulation comprising a seaweed extract and any one or more of the group consisting of an isoflavone and a plant elicitor.

In one embodiment of the invention, the seaweed extract may comprise of 100% pure seaweed extract. More preferably, the seaweed extract is a spray-dried seaweed extract.

In one embodiment of the invention, the isoflavone may comprise of a pure isoflavone or an isoflavone salt. More preferably, the isoflavone may comprise a formononetin, preferably 98% pure formononetin.

Further according to the invention, the plant elicitor may include any one or more of a harpin peptide, a harpin protein or zenith. In one embodiment of the invention, the harpin peptide or harpin protein may comprise of 1% pure harpin peptide or harpin protein.

Further according to the invention, the bio-stimulant formulation may include a biological. In a preferred embodiment of the invention, the biological may include any one or more of bacteria, fungi or viruses acting as a bio-fertilizer, bio-pesticide and/or bio-inoculant.

Yet further according to the invention, the bio-stimulant formulation may include a nutrient. In a preferred embodiment of the invention, the nutrient may comprise any one or more of zinc, boron, molybdenum, manganese, copper, cobalt, nitrogen, magnesium, potassium, nitrogen or calcium.

Yet further according to the invention, the bio-stimulant formulation may include a carbon source. In one embodiment of the invention, the carbon source may comprise a food source, in the form of sugar molasses; or a pure carbon, in the form of humic acid, fulvic acid and humin acid.

Furthermore, according to the invention, the bio-stimulant formulation may include a pesticide in the bio-stimulant formulation. In an embodiment of the invention, the pesticide may comprise of any suitable pesticide or a combination of pesticides for acting against a preferred pest or pests. Preferably, the pesticide may consist of any one or more of a fungicide, insecticide or a natural plant or organism extract displaying pesticidal properties. The natural plant extracts may include garlic, cinnamon, thyme or rosemary and the natural organism extract may include chitosan.

Further according to the invention, the bio-stimulant formulation may include a fluency agent. In a preferred embodiment of the invention, the fluency agent may comprise wax. More preferably, the wax may comprise of 100% of any static wax, such as ethene homopolymer.

Further according to the invention, the seaweed may comprise of a mass ratio ranging between 1% and 98% of the total formulation.

Further according to the invention, the isoflavone may comprise of a mass ratio ranging between 0.1% and 90% of the total formulation.

Further according to the invention, the plant elicitor may comprise of a mass ratio ranging between 1% and 60% of the total formulation.

Further according to the invention, the biological may comprise of a mass ratio ranging between 5% and 80% of the total formulation.

Further according to the invention, the nutrients may comprise of a mass ratio ranging between 10% and 80% of the total formulation.

Further according to the invention, the carbon source may comprise of a mass ratio ranging between 10% and 90% of the total formulation.

Further according to the invention, the pesticide may comprise of a mass ratio ranging between 0% and 70% of the total formulation.

Further according to the invention, the fluency agent may comprise of a mass ratio ranging between 5% and 80% of the total formulation.

According to a second aspect of the invention, there is provided a method for the preparation of a bio-stimulant formulation, which method comprises the steps of:
providing a seaweed extract;
providing any one or more of the group consisting of an isoflavone and a plant elicitor; and
mixing the seaweed and isoflavone and/or plant elicitor to form the formulation.

In one embodiment of the invention, the step of providing the seaweed extract into the formulation may comprise of providing 100% pure seaweed extract. More preferably, the seaweed extract is a spray-dried seaweed extract.

In one embodiment of the invention, the step of providing the isoflavone into the formulation may consist of providing a pure isoflavone or an isoflavone salt into the formulation. More preferably, the step of providing the isoflavone into the formulation may comprise of providing formononetin, preferably 98% pure formononetin into the formulation.

In one embodiment of the invention, the step of providing and mixing a plant elicitor into the formulation may include the step of providing and mixing a harpin peptide, harpin protein or zenith into the formulation, more preferably 1% pure harpin peptide, harpin protein or zenith.

Further according to the invention, a further step may include providing and mixing a biological into the formulation. In a preferred embodiment of the invention, the step of providing and mixing the biological may include providing and mixing a biological of any one or more of bacteria, fungi or viruses acting as a bio-fertilizer, bio-pesticide and/or bio-inoculant.

Yet further according to the invention, a further step may include providing and mixing a nutrient into in the formulation. In a preferred embodiment of the invention, the step of providing and mixing the nutrient into the formulation may include providing and mixing any one or more of zinc, boron, molybdenum, manganese, copper, cobalt, nitrogen, magnesium, potassium, nitrogen or calcium into the formulation.

Furthermore, according to the invention, a further step may include providing and mixing a pesticide into the formulation. In an embodiment of the invention, the step of providing and mixing the pesticide into the formulation may consist of providing and mixing into the formulation any suitable pesticide or a combination of pesticides for acting against a preferred disease, pest or pests. Preferably, the pesticide may consist of any one of more of a fungicide, insecticide or natural plant or organism extracts displaying pesticidal properties. The natural plant extracts may include garlic, cinnamon, thyme or rosemary and the natural organism extract may include chitosan.

In a preferred embodiment of the invention, the method includes the further step of providing and mixing a fluency agent into the formulation. The fluency agent may comprise wax. More preferably, the wax may comprise of 100% of any static wax, such as ethene homopolymer.

Further according to the invention, the step of providing seaweed may comprise of providing seaweed of a mass ratio ranging between 1% and 98% of the total formulation.

Further according to the invention, the step of providing the isoflavone may comprise of providing isoflavone of a mass ratio ranging between 0.1% and 90% of the total formulation.

Further according to the invention, the step of providing and mixing a plant elicitor may comprise providing plant elicitor of a mass ratio ranging between 1% and 60% of the total formulation.

Further according to the invention, the step of providing and mixing biological may comprise of providing biological of a mass ratio ranging between 5% and 80% of the total formulation.

Further according to the invention, the step of providing and mixing nutrients may comprise of providing nutrients of a mass ratio ranging between 10% and 80% of the total formulation.

Further according to the invention, the step of providing and mixing carbon source may comprise of providing carbon source of a mass ratio ranging between 10% and 90% of the total formulation.

Further according to the invention, the step of providing and mixing pesticide may comprise of providing pesticide of a mass ratio ranging between 0% and 70% of the total formulation.

Further according to the invention, the step of providing and mixing fluency agent may comprise of providing fluency agent of a mass ratio ranging between 5% and 80% of the total formulation.

According to a third aspect of the invention, there is provided a bio-stimulant formulation, in accordance with the first and second aspects of the invention, for use in any one or more of the following including:
improving crop vigour and yield;
enlarging leaves;
increasing root development and growth;
increasing nutrient and water uptake by crops;
improving soil quality;
enhancing crop colour;
providing rapid germination;
increasing adherence and even coating of the bio-stimulant to a seed;
improving crop vigour and yield by foliar application;
increasing fluency of coated seeds moving through a planter;
reducing dust formation during planting;
reducing the amount of bio-stimulant applied to seeds;
reducing the amount of bio-stimulant applied to leaves;
increasing crop resistance against pests and diseases;
increasing micro life in the soil;
increasing the health and sustainability of the soil;
reducing pest and diseases on the seed and in the soil;
improving fruit setting, fruit sizing and shelf life; and
turning on and Increasing the genetic potential of the plant.

### DETAILED DESCRIPTION OF THE INVENTION

The foregoing and other objects and features and advantages of the present invention will become more apparent from the following description of certain embodiments of the present invention by way of the following non-limiting examples exemplifying bio-stimulant formulations, according to the present invention.

It will be understood that, the formulation may be provided as a dry formulation for dry treatment, or a wet formulation for wet treatment as described below. The dry treatment is typically used for seed treatment, whereas the wet treatment is typically used for soil and/or plant treatment but may similarly be used as a wet seed treatment. In the instance of providing a dry treatment, a fluency agent, such as wax is provided in the formulation, whereas for a wet treatment, the fluency agent is not required.

All the mixing described can be done in a ribbon blender (not shown) or a pot with a propeller blade (not shown) and the various related steps and procedures in this respect will be well within the competence of a skilled person. A ribbon blender is preferred for dry powder mixing and a mixing pot with blade with liquids. Each mixture and blend should be mixed for no less than 5 minutes, preferably between 5-10 minutes between each ingredient/component added.

### First Example Embodiments

In a first example of various embodiments of the invention described directly below, the bio-stimulant formulation consists of seaweed and isoflavone as minimum components, with the rest of the components added in, in various alternatives, as required and which may be provided as a wet or dry formulation as indicated. Alternatively, provided as a third example of specific formulation examples, the bio-stimulant formulation will consist of seaweed and plant elicitor as minimum components, with the rest of the components added in, in various alternatives.

Formula 1

Firstly, spray-dried seaweed is added into the mixing bin and the process of mixing the well is started. Thereafter, the isoflavone is slowly added in units of 10% at a time as a powder in the mix after which the components are thoroughly mixed.

For the liquid formulation, dry isoflavone is provided and dissolved into a small amount of water using a wetting surfactant to break water tension and turn the powder into a wet paste. Once in a paste, another small amount of water is added until the isoflavone is completely in suspension. Once the isoflavone is in suspension, the liquid seaweed is added and mixed in for 5 minutes.

For dry and wet seed treatments, the following ratios may be used:

| Component | Mass | | Percentage |
|---|---|---|---|
| Seaweed | 5 | grams | 20% (but may range between 10-40%) |
| Isoflavone | 20 | grams | 80% (but may range between 40-90%) |

For wet/soil treatments, the following ratios may be used:

| Component | Mass | | Percentage |
|---|---|---|---|
| Seaweed | 300 | grams | 93% (but may range between 40-98%) |
| Isoflavone | 20 | grams | 7% (but may range between 2-30%) |

Formula 2

This process is to add the fluency agent namely the wax. The wax is mixed in the mixing pot and isoflavone is slowly added into the wax at 10% at a time and mixed for 5 minutes. Once blended well, the seaweed is added into the pot and blended for 5 minutes.

For dry seed treatments, the following ratios may be used:

| Component | Mass | | Percentage |
|---|---|---|---|
| Seaweed | 6 | grams | 15% (but may range between 5-40%) |
| Isoflavone | 20 | grams | 48% ((but may range between 10-60%) |
| Wax | 15 | grams | 37% (but may range between 15-80%) |

Formula 3

To add the plant elicitor, in these formulations, a harpin peptide or protein, as a dry mix, start by mixing the wax in the pot. The harpin is added into the pot and blended. Once blended, the isoflavone is added and mixed well for 5 minutes. Once mixed, the seaweed is added and mixed well.

Alternatively, all the components may be mixed together before adding into the wax by first mixing the harpin with isoflavone until fully blended. Then the seaweed is added and blended well, each of the aforementioned mixed well for a minimum of 5 minutes. Once blended well, add this complete mix into the wax and mix thoroughly.

As a wet mix, start with the seaweed and mix in the pot. The suspended isoflavone is added next and mixed well. Once mixed, liquid harpin or zenith is added into the pot and mixed for 5 minutes.

For dry seed treatments, the following ratios may be used:

| Component | Mass | | Percentage |
|---|---|---|---|
| Seaweed | 6 | grams | 14% (but may range between 5-60%) |
| Isoflavone | 20 | grams | 45% (but may range between 5-60%) |
| Wax | 14 | grams | 32% (but may range between 10-60%) |
| Harpin | 4 | grams | 9% (but may range between 2-30%) |

For wet seed treatments, the following ratios may be used:

| Component | Mass | | Percentage |
|---|---|---|---|
| Seaweed | 6 | grams | 20% (but may range between 5-50%) |
| Isoflavone | 20 | grams | 66% (but may range between 5-60%) |
| Harpin | 4 | grams | 14% (but may range between 2-40%) |

For soil treatments, the following ratios may be used:

| Component | Mass | | Percentage |
|---|---|---|---|
| Seaweed | 300 | grams | 71% (but may range between 20-90%) |
| Isoflavone | 20 | grams | 5% (but may range between 2-40%) |
| Harpin | 100 | grams | 24% (but may range between 10-60%) |

Formula 4

To add the biological as a dry mix, start by mixing the wax in the pot. The rest of the components are slowly added mixed each time for 5 minutes. This is done by firstly adding the harpin into the wax, then adding isoflavone and then the seaweed and mix for 5 minutes to complete. Once mixed well, add the biological and mix for 5 minutes.

Alternatively, all the components may be mixed together first and then added at once into the wax.

For a wet mix, the seaweed is first added into the pot and mixed. The harpin is added slowly in and blended. Then, the suspension isoflavone is added and mixed well. Once mixed well add the biological mix for 5 minutes.

For dry seed treatments, the following ratios may be used:

| Component | Mass | | Percentage |
|---|---|---|---|
| Seaweed | 6 | grams | 6% (but may range between 2-40%) |
| Isoflavone | 20 | grams | 20% (but may range between 2-60%) |
| Wax | 15 | grams | 15% (but may range between 5-50%) |
| Harpin | 4 | grams | 4% (but may range between 2-45%) |
| Biological | 55 | grams | 55% (but may range between 15-75%) |

For wet seed treatments, the following ratios may be used:

| Component | Mass | | Percentage |
|---|---|---|---|
| Seaweed | 6 | grams | 7% (but may range between 2-40%) |
| Isoflavone | 20 | grams | 24% (but may range between 2-50%) |
| Harpin | 4 | grams | 5% (but may range between 2-50%) |
| Biological | 55 | grams | 64% (but may range between 10-75%) |

For soil treatments, the following ratios may be used:

| Component | Mass | | Percentage |
|---|---|---|---|
| Seaweed | 300 | grams | 21% (but may range between 10-50%) |
| Isoflavone | 20 | grams | 2% (but may range between (1-20%) |
| Harpin | 100 | grams | 7% (but may range between 1-30%) |
| Biological | 1000 | grams | 70% (but may range between 10-80%) |

Formula 5

To include the nutrients, the nutrients are simply added into formula 4.

For dry seed treatments, the following ratios may be used:

| Component | Mass | | Percentage |
|---|---|---|---|
| Seaweed | 6 | grams | 6% (but may range between 2-40%) |
| Isoflavone | 20 | grams | 20% (but may range between 2-40%) |
| Wax | 15 | grams | 15% (but may range between 5-35%) |
| Harpin | 4 | grams | 4% (but may range between 1-25%) |
| Biological | 55 | grams | 27.5% (but may range between 5- |
| | | | 70%) |
| Nutrients | 100 | grams | 50% (but may range between 10-80%) |

For wet seed treatments, the following ratios may be used:

| Component | Mass | | Percentage |
|---|---|---|---|
| Seaweed | 6 | grams | 4% (but may range between 2-50%) |
| Isoflavone | 20 | grams | 10% (but may range between 2-50%) |
| Harpin | 4 | grams | 2% (but may range between 1-30%) |
| Biological | 55 | grams | 30% (but may range between 5-70%) |
| Nutrients | 100 | grams | 54% (but may range between 10-80%) |

For soil treatments, the following ratios may be used:

| Component | Mass | | Percentage |
|---|---|---|---|
| Seaweed | 300 | grams | 16% (but may range between 5-40%) |
| Isoflavone | 20 | grams | 1% (but may range between 0.1-20%) |
| Harpin | 100 | grams | 5% (but may range between 2-25%) |
| Biological | 1000 | grams | 52% (but may range between 10-80%) |
| Nutrients | 500 | grams | 26% (but may range between 10-80%) |

Formula 6

To add the carbon source, the carbon is simply added with the elements and blended well together wet or dry. Once blended this mixture is added to formula 4 and mixed for 5-10 minutes.

For dry seed treatments, the following ratios may be used:

| Component | Mass | | Percentage |
|---|---|---|---|
| Seaweed | 6 | grams | 6% (but may range between 2-20%) |
| Isoflavone | 20 | grams | 20% (but may range between 2-30%) |
| Wax | 20 | grams | 15% (but may range between 5-40%) |
| Harpin | 4 | grams | 4% (but may range between 1-25%) |
| Biological | 55 | grams | 27.5% (but may range between 10- |
| | | | 80%) |
| Nutrients | 100 | grams | 50% (but may range between 15-80%) |
| Carbon | 100 | grams | 32% (but may range between 20-90%) |

For wet seed treatments, the following ratios may be used:

| Component | Mass | | Percentage |
|---|---|---|---|
| Seaweed | 6 | grams | 2% (but may range between 1-35%) |
| Isoflavone | 20 | grams | 7% (but may range between 1-40%) |
| Harpin | 4 | grams | 2% (but may range between 1-30%) |
| Biological | 55 | grams | 20% (but may range between 5-70%) |
| Nutrients | 100 | grams | 35% (but may range between 10-80%) |
| Carbon | 100 | grams | 34% (but may range between 10-80%) |

For soil treatments, the following ratios may be used:

| Component | Mass | | Percentage |
|---|---|---|---|
| Seaweed | 300 | grams | 13% (but may range between 5-40%) |
| Isoflavone | 20 | grams | 1% (but may range between 0.5-20%) |
| Harpin | 100 | grams | 4% (but may range between 1-30%) |
| Biological | 1000 | grams | 42% (but may range between 10-70%) |
| Nutrients | 500 | grams | 20% (but may range between 10-70%) |
| Carbon | 500 | grams | 20% (but may range between 10-70%) |

### Second Example Embodiment

In a second embodiment of the invention, the bio-stimulant formulation consists of 100% wax as the fluency agent; 1% concentration of harpin protein; 100% concentration of dried seaweed extract; 97% concentration of formononetin; bacteria, fungi and/or viruses as a biological; zinc, boron, nitrogen and/or magnesium as a nutrient; and any suitable pesticide.

### Example 1

As a first example, the formulation is produced by firstly introducing a mass ratio of 5% of harpin protein into a mass ratio of 24% wax. The harpin protein is milled down first to obtain a fine powder. The finer particles allow better dispersion of the harpin throughout the wax and improves binding of the harpin to the other ingredients and the seed. The formulation is shaken for 10 minutes to ensure complete dispersion of the harpin protein throughout the wax. Next a mass ratio of 14% seaweed extract is introduced to the formulation, which is again shaken for 10 minutes. If necessary, the seaweed extract is also milled to a fine powder before introduction into the formulation. Then a mass ratio of 8% biological is mixed into the formulation. Thereafter a mass ratio of 33% formononetin is added to the formulation and mixed for another 10 minutes. Lastly, a suitable nutrient, or nutrients, is introduced into the mixture in a mass ratio of 16% to the total formulation.

### Example 2

As a second example, the formulation is produced by firstly introducing a mass ratio of 6% harpin protein into a mass ratio of 32% wax. The harpin protein is first milled down to a fine powder. The formulation is shaken for 10 minutes to ensure complete dispersion of the harpin protein throughout the wax. Next a mass ratio of 18% seaweed extract is introduced to the formulation, which is again shaken for 10 minutes. If necessary, the seaweed extract is milled to a fine powder. Thereafter a mass ratio of 44% formononetin is added to the formulation and mixed for another 10 minutes.

### Example 3

As a third example, the formulation is produced by firstly introducing a mass ratio of 4% of harpin protein into a mass ratio of 24% wax. The harpin protein is first milled down to a fine powder. The formulation is shaken for 10 minutes to ensure complete dispersion of the harpin protein throughout the wax. Next a mass ratio of 9% seaweed extract is introduced to the formulation, which is again shaken for 10 minutes. If necessary, the seaweed extract is milled to a fine powder. Then a mass ratio of 7% biological is mixed into the formulation. Thereafter a mass ratio of 24% formononetin is added to the formulation and mixed for another 10 minutes. Then any one or more suitable nutrient is introduced into the mixture in a mass ratio of 11% and any one or more suitable pesticide is introduced into the formulation in a mass ratio of 21%.

The final formulation is light brown in colour, having a fine particle size. Different ratios of the individual ingredients are used for different seed crops. For example, a bio-stimulant formulation consisting of 14% w/w wax, 3% w/w harpin, 20% w/w formononetin and 5% w/w dried seaweed extract if preferable for use on maize. 40-60 g is applied to a 25 kg bag of maize seed, which usually contains approximately 60 000 seeds. Another example of a bio-stimulant formulation preferable for use on soya bean seed consists of 12% w/w wax, 3% w/w harpin, 11% w/w formononetin and 4% w/w dried seaweed extract. Of this formulation it is preferable to apply 20-50 g to a 25 kg bag of soya beans containing approximately 140 000 seeds. A further example of a bio-stimulant formulation preferable for use on wheat seed, consists of 10% w/w wax, 3% w/w harpin, 5% w/w formononetin and 4% w/w dried seaweed extract. 40-80 g of this bio-stimulant is applied to a bag of wheat seed.

The prepared bio-stimulant formulations according to the invention is applied as a dry seed dressing to seed in a seed bin of a planter, attached to a tractor. The formulation of the invention is precisely calculated in order to produce the optimum synergistic effects between the various ingredients, using the lowest possible amount per ingredient. Due to the synergy between the ingredients, a lower dosage of each ingredient produces a higher efficacy as compared to the know dosages of the individual ingredients.

The bio-stimulant according to the invention may also be formulated for use in plant/foliar and/or soil-drench applications when used as a wet formulation. In the wet formulation applications specifically, no fluency agent is required as adherence to a seed is not required, but still providing the benefits discussed herein to the foliar and/or drench applications.

It will further be understood that the above examples and formulations are illustrative only and may be varied without departing from the scope of the invention. In this respect, the seaweed and isoflavone may be combined with any one or more of the other components namely plant elicitor, biological, nutrients, carbon and wax. For example, in Formula 4, the harpin may be excluded from the formula which will result in different formulations. Therefore, any mass ratio of the components may be provided without departing from the scope of the invention resulting in mass ratio possibilities beyond the scope of the above formulations and examples and which may be provided according to the requirements of a particular application.

### Third Example Embodiments

In a third example of various embodiments of the invention described directly below, the bio-stimulant formulation consists of seaweed and the plant elicitor, as harpin, as minimum components, with the rest of the components added in, in various alternatives, as required and which may be provided as a wet or dry formulation as indicated.

Foliar or Soil Application Formula:

| Component | Mass | Percentage |
|---|---|---|
| Harpin | 100-150 grams | 10-60% (preferably 27%) |
| Dry seaweed | 200-400 grams | 20-90% (preferably 73%) |

Seed Treatment Formula:

| Component | Mass | | Percentage |
|---|---|---|---|
| Harpin | 5 | grams | 16% (but may range between 4-50%) |
| Seaweed | 6 | grams | 19% (but may range between 5-70%) |
| Wax | 20 | grams | 65% (but may range between 15-85%) |

Foliar or Soil Application Formula Including a Nutrient:

| Component | Mass | | Percentage |
|---|---|---|---|
| Harpin | 100-150 | grams | 4% (but may range between 1-40%) |
| Dry seaweed | 200-400 | grams | 12% (but may range between 4-50%) |
| Nutrient | 1000-3000 | grams | 84% (but may range between |
| | | | 10-95%) |

Foliar or Soil Application Formula Including a Nutrient and a Biological in the Form of a Biopesticide:

| Component | Mass | | Percentage |
|---|---|---|---|
| Harpin | 100-200 | grams | 1-30% (preferably 4%) |
| Seaweed | 300-500 | grams | 5-40% (preferably 8%) |
| Nutrients | 2000-3000 | grams | 10-60% (preferably 44%) |
| Biopesticide | 1000-3000 | grams | 10-60% (preferably 44%) |

### DISCUSSION

Both the isoflavone and the seaweed are bio-stimulants and can be applied dry or wet to seed or the soil. Should a dry formulation be applied, a spray-dried seaweed powder formulation is used with dry isoflavone. Both isoflavone and seaweed are also available in a liquid form and can be combined into a liquid/wet formulation.

The seaweed contains many plant hormones and elements which promote germination of seed and stimulate new root development of plants. These plant hormones in seaweed, to name a few, include auxins, cytokinins, gibberelins, abscisic acid and ethylene. It also contains essential macro- and micro-elements that feed the plant. The increase in root development increases the rhizosphere area in the soil around the roots allowing for a higher population on micro life. The seaweed also contains carbon and works as a food source for the beneficial micro-organisms allowing them to increase populations.

The isoflavone is a root exudate which stimulates many micro-organisms in the soil and stimulates roots development. This active ingredient activates bacteria and fungi as it passes through the soil with water and can stimulate micro life deeper in the soil allowing more micro life to grow far beneath the plant roots towards the root zone to colonize the roots within the rhizosphere around the roots. The increase in more micro life will increase additional root development. Isoflavone also stimulates plant root development and promotes a stronger root growth. It has two effectives, one to stimulate the plant roots and the other to stimulate the microbes.

It was, however, surprisingly found that the novel benefit of combining the seaweed and isoflavone is to increase production, seed germination and speed of growth which was not previously described. The combination of seaweed and isoflavone works particularly well in combination. The increased root structure obtained from both the seaweed and the isoflavone allows for a larger area of micro life and a higher population of micro-organisms to colonize and live in the rhizosphere. There are accordingly more roots to colonize. More roots, in turn, means more space on the root for fungi and bacteria to colonize the roots. One of the main fungi in the soil that is stimulated by isoflavone is Mycorrhizal fungi which is a beneficial fungus that feeds plant roots. Isoflavone also stimulates phosphate solubilizing bacteria which is essential to break down fixed phosphates into an available form for the plant. Many other fungi and bacteria are stimulated as well.

Should the application of seaweed and isoflavone be applied as a seed treatment in a dry formulation, the added wax allows for lubrication and is electrostatic assisting the bio-stimulants in the formulation to stick onto the seed evenly and allows for a dry seed treatment in the planting bins during planting. The wax lubricates the seed and quickly moves through the planting bin sticking the bio-stimulants to all the seeds evenly with no dust and without blocking the planter.

The isoflavone, such as formononetin on its own does not adhere completely to the seed surface, and therefore a greater amount formononetin is used when applied singularly to the seeds. As mentioned, the wax acts as a static attractant and binds the formononetin particles to the seed. Therefore, it is possible to use a dosage of formononetin that is lower than normally required, which reduces wastage and cost. The formononetin additionally boosts the micro-organisms in the biological, improves the working of biological inoculants and increases soil fertility and soil life. Increased soil life directly leads to increased water and nutrient uptake which in turn enables a plant to resist drought stress.

Applied as a seed treatment or to the soil, the advantage of adding a plant elicitor in the formulation is to stimulate the genetics of the plant that add extra benefits. An elicitor is also known as a bio-stimulant. Again, should this be applied as a wet seed treatment application there will be no need for the wax component.

A plant elicitor activates a plant. It does this by sending a signal to the plant, the plant reacts by increasing its natural immune system and speeds up growth. The increase in the boosted immune system fights off diseases naturally. The movement of elements within the plants are seen and an increase in photosynthesis is noted. The plant elicitor can be harpin protein, harpin peptide or Zenith. Zenith, which contains a lot of oligogalacturonides and contains DAMP molecular patterns, can also be used within the formulation to replace harpin protein or harpin peptides. Zenith is a liquid formulation and would normally only be used in a wet liquid formulation for seed applications or soil application. The plant elicitor stimulates the plant to reduce diseases, increase nutrient uptake, increase photosynthesis, promote root development all adding to a synergetic effect with the other bio stimulants in the formulation.

The harpin protein is normally applied as a wet treatment, since the harpin protein particles do not bind to seed in a powder form. The wax allows the harpin protein powder to bind to the seed. Harpin protein is known to influence the self-defence mechanisms of a plant, which causes the plant to increase its uptake of nutrients and water. The plant therefore develops a larger root system which in turn allows the isoflavone to colonize a larger area in the soil. This elevated defence response in turns allows a more efficient working of the biological. The harpin also stimulates the roots to increase uptake of the seaweed. The particular combination of seaweed and harpin yields unexpected increased results as a bio-stimulant.

Turning back to seaweed, the seaweed extract contains high levels of plant hormones and carbohydrates, which increases cellular division and activity resulting in faster overall growth. On its own, it is unable to bind to seeds in a dry form. The wax also binds the seaweed extract to the surface of the seeds. This method allows more seaweed particles to bind to the surface of the seed, where normal application was unable to allow such an increased concentration to be applied. This makes it possible to add lower amounts of seaweed into a bio-stimulant formulation, as the usage of dried seaweed extract in a bio-stimulant formulation has not been possible before this invention. The carbohydrate in the seaweed further provides nutrition to micro-organisms in the soil and the biological and thus increases the functionality of the biological. The micro-organisms in the soil is firstly activated by the formononetin which are then able to feed on the seaweed extract. The harpin protein allows for an increased uptake of the seaweed by the plant, which delivers beneficial plant hormones to the plant, further increasing the growth and vigour of the plant.

The biological added to either a wet or dry formulation assists to increase the soil life, to build soil health, or inoculant the plant to help increase nutrients, or work as a bio-pesticide to kill other harmful pathogen or pests or a combination of the above. There might be little or zero soil life in the cultivated soil and by adding a biological into the formulation soil life is quickly increased. The micro-organism in the biological help break down fixed nutrients to be more available to the plant, help break down the soil to improve humus content, secrete enzymes which stimulate the plant and stimulate any native micro life, help absorb elements out the atmosphere and work as a biological to increase nutrients and reduce chemical fertilizers. The biological also acts as a buffer in the soil and protects the roots from harmful pathogens wanting to attack the roots. This allows the bio-stimulants to have their full effect to grow a quicker, healthier plant. The biological also contains enzymes and is normally formulated in a sugar molasses base. The biological may consist of up to 40 different specie groups consisting of bacteria and fungi.

Nutrients are added to the mixture, because the harpin protein urges the plant to increase its uptake of nutrients. The harpin protein also stimulates photosynthesis which requires energy in the form of nutrients. The plant therefore is able to absorb increased amounts of beneficial nutrients with which to fuel photosynthesis and growth. Both the biological and the hormones provided in the seaweed extract encourage nutrient uptake. The nutrients in the formulation as used to help germinate seed, and are needed in the development of roots and are needed to feed the biological in the formulation and feed native biologicals in the soil. These nutrients will furthermore assist and work on all the above needs to make sure the plant and microbes have sufficient elements to grow and populate and eliminate any weak links. These nutrients can be used in low concentrations but have big effectives. The nutrients may include zinc, boron, molybdenum, manganese, copper and cobalt. All these elements are needed during the germination stage of seed and root development of plants.

The carbon component of the formulation is the last key in the formulation to obtain successful results.

The carbon consists of two parts:

The first part is the sugar molasses which feeds the bacteria and is a food source for the biological within the formulation. It also provides a suitable environment to store the biological in a bottle for up to 5 years.

The second part is pure carbon, which is mined out the earth from decomposed carbon sources. This carbon humate is known as humic, fulvic, and humin acid coming from Leonardite. Leonardite is a pure carbon source and helps build soil health. Its formed over millions of years from bacteria feeding on carbon and secreting acids which form humates.

Leonardite is essential within this formulation to:
feed the biological microbes in the formulation;
create a healthy environment for our biologicals;
feed the native microbes in the soil;
chelate the nutrient elements in the formulation and the soil into a more organic form for the plant;
improve the cation exchange capacity in the soil; and
improve water retention.

Pesticides as discussed above, may be added to the formulation as and when extra defence against pests and diseases are required.

The combination of seaweed and a plant elicitor, such as harpin has surprisingly found to be particularly effective.

Harpin protein is currently only commercially available as a dry powder. Seaweed is most commonly found as a liquid in a ready to use formulation. Spray dried seaweed is provided in a ready to use dry formulation with a small particle size that can dissolve in water. Therefore, only spray dried seaweed can usually be formulated with dry harpin protein as both products come in dry formulation.

However, harpin protein cannot be dissolved in water or within a liquid formulation of seaweed if you want to produce a product to have a shelf life. Once the harpin protein comes in contact with moisture or liquid it starts to break down within 8-24 hours so one cannot formulate it into a liquid product and have a shelf life to sell months later.

Therefore, to use the dry formulation of harpin protein and a unique spray dried sea weed formulation that are compatible to formulate together in a dry form that is stable with a long shelf life has been invented.

The synergy between the harpin protein and seaweed includes that harpin triggers the plant to increase its natural immune system and to speed up growth. Seaweed has many plant hormones in it that also help speed up growth through enlarging cells and producing more cells within the plant. There is a big, unexpected synergistic effect by combining these two compounds. For example, on fruit: Harpin protein is used to increase fruit set and size on fruit trees. Seaweed is used to increase fruit set and fruit size as well. Combining them allows increased and consistent results.

Another benefit of harpin in this invention is to increase photosynthesis and turn on the plants immune system. The photosynthesis boosts the plants energy levels allowing the plant to set more fruit and relief stress levels at the point within the growing cycle. The immune system that is turned on speeds up nutrient movement within the plant, mainly calcium. Calcium is used in a plant as a messenger to pass on a message from cell to cell when the plant is under attack (false attack from an application of harpin). The plant builds up more calcium levels in its cells to try protect itself from this attack. Calcium is used to build strong cell walls to protect itself. Harpin not only helps absorb calcium into a plant, it trans locates it quicker.

Harpin will trigger all nutrients to be absorbed quicker with higher levels absorbed and trans located all of them quicker within a plant, Calcium is one example.

The use of seaweed at the same time turns on the plant to expand its cells and encourage new cells to form from its hormones. These enlarged cells and new cells will also receive the higher levels of calcium because of the harpin application. The new cells filled with higher levels of calcium enable the plant to set more fruit and multiply application during fruit development will encourage quality fruit growth. Harpin and seaweed would be applied a few times during a season to a crop.

Higher levels of photosynthesis with increased calcium levels with the added advantage of plant hormones to speed up cell division and cell enlargement will give better effects on fruit setting, fruit enlargement and both compounds help reduce stress levels within the plant. The seaweed also contains needed minerals that are taken up quicker that can assist to feed the plant during this growth phase after an application.

Spray dried seaweed is also the only seaweed that contains high levels of gibberellin which are used to enlarge cells. The combination of gibberellins and harpin is a perfect combo to set fruit and enlarge fruit. Many farmers use synthetic gibberellic acid to set fruit and increase fruit size. Spray dried seaweed contain high levels of natural gibberellic acids. Seaweed also contains potassium which is an element the plant needs to enlarge fruit size.

Adding the combination of dry Harpin protein with spray dried seaweed into a nutrient based fertilizer has added benefits. The use of a calcium application with harpin and spray dried seaweed is a unique combination to increase set fruit, increase fruit size, product a better quality fruit with less fruit split reduced fruit drop and increase shelf life of fruit, It will also reduce multiply stresses, prevent diseases, reduced calcium disorders and reduce pesticide application.

Calcium on its own moves very slowly in a plant due to this causes many calcium disorders are found in plants. Harpin as described above is a compound used to increase calcium movement and to increase calcium uptake. When mixing harpin with a specialized calcium fertilizer the plant will absorb more calcium and translocate the calcium quicker within the plant. During cell division stages of a fruit calcium is vital to build strong cells and protect the plant from disease. The calcium can now get into the plant in higher levels and get to work faster within the small window period of cells division to build stronger cells, help with cell division, reduce fruit dropping, reduce fruit splitting, stop calcium deficiency disorders in fruit like “Pitter bit” on Apples or “Blossom end rot” in fruit and vegetables.

From a disease control perspective harpin and calcium also work well. Harpin turns on the natural immune system of the plant and the extra uptake and translocation of calcium helps build stronger cells walls to protect itself giving the plant the ability to protect itself naturally without having to use a pesticide. By adding seaweed into the same application further assists the plant by reducing stress levels and feeding the plant with vital nutrients and hormones, antioxidants that also help defend the plant. The healthier the plant the better it can defend itself.

When a plant is growing too fast from normally excess nitrogen or from high temperature the combination of harpin and seaweed and calcium works very well. The harpin and seaweed will boost the plant ability to survive the high temperatures by reducing stress levels on multiply levels within the plant, it will also allow more calcium to quickly be absorbs and move to the new growth areas. Calcium normally cannot keep up with its concentration in a plant if the plant grows to quick which causes calcium disorders.

The benefit of harpin and seaweed and a biological (for example a biopesticide) and calcium will provide a product to fight against diseases more naturally. Harpin turns on the natural immune system and boosts energy in the plant. Seaweed reduces stress, improves energy, growth and health and feeds the plant. The calcium strengthens the cells walls rapidly because of harpin. The biopesticide works directly against the disease killing it. This unique formulation can be used to reduce chemical pesticides and improve crop yields and quality at the same time with no residues of harmful pesticides.

Seed treatment benefits of the combination of harpin and seaweed provide is a good combination to give a seed the ability to germinate and develop a rapid roots system to survive. The harpin triggers the plant to germinate and grow a stronger quicker roots system and turns of its natural defence to tolerance stress levels from the environment and from diseases and helps flight off soil born nematodes that feed on plant roots. The seaweed helps speed up root development through its hormones and helps feed the plant vital minerals and nutrients at its early age to build a stronger plant. The seaweed also reduces stress levels at this stage and helps produce a stronger plant that can defend itself.

It is therefore envisaged that the following combinations are particularly useful:
Harpin and seaweed;
Isoflavone and seaweed;
Harpin and seaweed and nutrients;
Isoflavone and seaweed and nutrients;
Harpin and seaweed and wax;
Isoflavone and seaweed and wax
Harpin and isoflavone and seaweed and wax;
Harpin and isoflavone and seaweed and wax and biologicals;
Harpin and isoflavone and seaweed and wax and nutrients;
Harpin and isoflavone and seaweed and wax and nutrients and biologicals;
Harpin and isoflavone and seaweed and wax and nutrients and biologicals and biopesticide.

It is accordingly asserted that the disadvantages of known bio-stimulant formulations are overcome, or at least alleviated.

The invention provides the benefits of, inter alia:
improving crop vigour and yield;
enlarging leaves;
increasing root development and growth;
increasing nutrient and water uptake by crops;
improving soil quality;
enhancing crop colour;
providing rapid germination;
increasing adherence and even coating of the bio-stimulant to a seed;
improving crop vigour and yield by foliar application;
increasing fluency of coated seeds moving through a planter;
reducing dust formation during planting;
reducing the amount of bio-stimulant applied to seeds;
reducing the amount of bio-stimulant applied to leaves;
increasing crop resistance against pests and diseases;
increasing micro life in the soil;
increasing the health and sustainability of the soil;
reducing pest and diseases on the seed and in the soil;
improving fruit setting, fruit sizing and shelf life; and
turning on and Increasing the genetic potential of the plant.

The synergy between the various ingredients comprising the bio-stimulant of the invention allows for a decrease in the amount of individual ingredients added to the formulation since the synergy provides an increased efficacy as compared to applying individual ingredients one at a time. Furthermore, the synergy allows for on demand application to seeds in the field, decreasing the amount of resources needed to apply a bio-stimulant.

The invention further provides for effective application as a dry seed treatment which was not previously described. The overall and increased efficacy of stimulation of a plant, soil or seed and its unique method of application is achieved with invention leading to improved application of bio-stimulants to soil, plant or seed which may be carefully managed in terms of safety and efficacy aspects to ensure sustainable and effective agriculture.

1. A bio-stimulant formulation comprising a seaweed extract and one or more of an isoflavone and a plant elicitor.

2. The bio-stimulant formulation of claim 1, wherein the seaweed extract comprises 100% pure seaweed extract.

3. The bio-stimulant formulation of claim 1, wherein the isoflavone includes one or more of a pure isoflavone and an isoflavone salt.

4. The bio-stimulant formulation of claim 1, wherein the plant elicitor includes one or more of a harpin peptide, a harpin protein, and a zenith.

5. The bio-stimulant formulation of claim 4, wherein the harpin peptide or harpin protein comprises 1% pure harpin peptide or harpin protein.

6. The bio-stimulant formulation of claim 1, wherein the bio-stimulant formulation further comprises a biological comprising one or more of bacteria, fungi and viruses acting as a bio-fertilizer, bio-pesticide and/or bio-inoculant.

7. The bio-stimulant formulation claim 1, wherein the bio-stimulant formulation further comprises a nutrient comprising one or more of zinc, boron, molybdenum, manganese, copper, cobalt, nitrogen, magnesium, potassium, nitrogen, and calcium.

8. The bio-stimulant formulation of claim 1, wherein the bio-stimulant formulation further comprises a carbon source.

9. The bio-stimulant formulation claim 1, wherein the bio-stimulant formulation includes a pesticide comprising any one or more of a fungicide, insecticide, and a natural plant or organism extract displaying pesticidal properties.

10. The bio-stimulant formulation of claim 1, wherein the bio-stimulant formulation further comprises a fluency agent.

11. The bio-stimulant formulation of claim 10, wherein the fluency agent comprises 100% of a static wax.

12. The bio-stimulant formulation of claim 1, wherein the bio-stimulant formulation is characterized by one or more of the following:
the seaweed is included in a mass ratio ranging between 1% and 98% of the total formulation;
the isoflavone comprises is included in a mass ratio ranging between 0.1% and 90% of the total formulation; and
the plant elicitor comprises is included in a mass ratio ranging between 1% and 60% of the total formulation.

13. (canceled)

14. (canceled)

15. The bio-stimulant formulation of claim 6, wherein the biological is included in a mass ratio ranging between 5% and 80% of the total formulation.

16. The bio-stimulant formulation of claim 7, wherein the nutrients is included in a mass ratio ranging between 10% and 80% of the total formulation.

17. The bio-stimulant formulation of claim 8, wherein the carbon source is included in a mass ratio ranging between 10% and 90% of the total formulation.

18. The bio-stimulant formulation of claim 9, wherein the pesticide is included in a mass ratio ranging between 0% and 70% of the total formulation.

19. The bio-stimulant formulation of claim 10, wherein the fluency agent is included in a mass ratio ranging between 5% and 80% of the total formulation.

20. A method for the preparation of a bio-stimulant formulation, which method comprises the steps of:
providing a seaweed extract;
providing one or more of an isoflavone and a plant elicitor; and
mixing the seaweed and isoflavone and/or plant elicitor to form the formulation.

21. The method for the preparation of a bio-stimulant formulation of claim 20, wherein the step of providing the seaweed extract into the formulation comprises providing 100% pure seaweed extract.

22. The method for the preparation of a bio-stimulant formulation of claim 20, wherein the step of providing the isoflavone into the formulation comprises providing a pure isoflavone or an isoflavone salt into the formulation.

23. The method for the preparation of a bio-stimulant formulation of claim 20, wherein the step providing and mixing a plant elicitor into the formulation comprises providing one or more of a harpin peptide, harpin protein, and zenith.

24. The method for the preparation of a bio-stimulant formulation of claim 20, including any one or more of the subsequent steps comprising:
providing and mixing a biological including one or more of bacteria, fungi, and viruses acting as a bio-fertilizer, bio-pesticide and/or bio-inoculant into the formulation;
providing and mixing a nutrient including one or more of zinc, boron, molybdenum, manganese, copper, cobalt, nitrogen, magnesium, potassium, nitrogen and calcium into the formulation in a mass ratio ranging between 10% and 80% of the total formulation;
providing and mixing a pesticide including one of more of a fungicide, insecticide and a natural plant or organism extract displaying pesticidal properties into the formulation in a mass ratio ranging between 0% and 70% of the total formulation;
providing and mixing a carbon source into the formulation in a mass ratio ranging between 10% and 80% of the total formulation; and
providing and mixing a fluency agent into the formulation in a mass ratio ranging between 5% and 80% of the total formulation.

25. The method for the preparation of a bio-stimulant formulation of claim 20, wherein the method is characterized by one or more of the following:
providing seaweed comprises providing seaweed in a mass ratio ranging between 1% and 98% of the total formulation;
providing the isoflavone comprises providing isoflavone in a mass ratio ranging between 0.1% and 90% of the total formulation; and
providing and mixing a plant elicitor comprises providing plant elicitor in a mass ratio ranging between 1% and 60% of the total formulation.

26. (canceled)

27. (canceled)

28. The method for the preparation of a bio-stimulant formulation of claim 24, wherein the step of providing and mixing a biological comprises providing biological in a mass ratio ranging between 5% and 80% of the total formulation.

29-35. (canceled)
